(19) United States
(12) Patent Application Publication
(10) Pub. No.: US 2002/0090852 A1
(43) Pub. Date: Jul. 11, 2002

(54) Fluorescent lamp holder

(76) Inventor: Yung-Chuan Lin, Junghe (TW)

Correspondence Address: OPPENHEIMER WOLFF & DONNELLY LLP, P.O. BOX 52037, Palo Alto, CA, 94306, US

(21) Appl. No.: 09/973,173

(22) Filed: Oct. 4, 2001

(30) Foreign Application Priority Data
Nov. 7, 2000 (TW) 89219338

(51) Int. Cl. H01R 33/02

(52) U.S. Cl. 439/226

(57) ABSTRACT

A fluorescent lamp holder has a socket circuit unit disposed on the lamp socket in the assembly. The distribution wiring related to the holder is disposed in the socket circuit unit previously, where the socket circuit unit working as the distributional junction. The user can set up the electronic starter easily and correctly in installation of the lamp. Furthermore, the electronic starter can be divided into two units previously. These two units are matched with the lamp sockets on the two extremities of the lamp holder, which can improve the function of heat transfer and the convenience of maintenance. It can also reduce the risk of circuit failure and the cost of maintenance.

### FIELD OF THE INVENTION

The present invention relates to a fluorescent lamp holder, and more particular to a fluorescent lamp holder equipped with an electronic starter unit. The fluorescent lamp holder according the present invention can be easy installed and maintained by the consumer for the purpose of energy saving and environmental protection.

### BACKGROUND OF THE INVENTION

Energy saving and environmental protection are the common problems must be solved by human being. From the viewpoint of entirety, the power consumption is increasing substantially with the development of economics and civilization. The power consumption for lighting is closely related to the civilization index and the productivity, which is proportional to the factors mentioned above. Thus reducing the power consumption of lighting will be more contributed to the energy saving and environmental protection of the whole world.

The fluorescent lamp is the most economical lighting equipment of the world. The starter is the key component of the fluorescent lamp in common use. Starters can be classified into two types: one is the inductive starter; the other is the electronic starter, the latter is more efficient than the former in energy saving. The inductive starters are general used than electronic starters, because the structure of the latter is more complex than the former. As shown in FIG. 2, there are six external wires 2 in an electronic starter 1 which are installed in the conventional fluorescent lamp. It is very difficult for the general public to set up such a complicated wire connection. Such a complex structure of the electronic starter also hinders the professional electrician from installation and maintenance.

### SUMMARY OF THE INVENTION

In view of the above, the present invention is to provide a fluorescent lamp holder with improved structure, which is more economical, convenient and useful.

One aspect of the present invention is to provide a fluorescent lamp holder where the socket circuit units are disposed on the lamp sockets in advance. User can use the electronic starter matched with the socket unit to install or maintain the fluorescent lamp directly, quickly and properly. The electronic starter has the socket circuit unit matched with the socket unit in the lamp holder.

In another aspect, the present invention provides a fluorescent lamp holder in which the electronic starter is separated into two socket circuit units previously. These two socket circuit units are matched with the lamp sockets on the two extremities of the lamp holder. The separated socket circuit units can transfer the heat generated from the circuit more efficiently. It can also reduce the risk of circuit failure and the cost of maintenance, and improve the convenience of installation and maintenance.

In a further aspect, the present invention provides a fluorescent lamp holder in which the starting capacitor is separated from the electronic starter and disposed in the holder structure previously. The structure of the electronic starter is simplified because the separation of the starting capacitor, which can reduce the cost of maintenance for the replacement of electronic starter. It can also reduce the number of the connecting pins for efficiency and convenience.

The fluorescent lamp holder of the present invention has at least the following advantages:

1. The structural improvement of the electronic starter in the prefabricated socket circuit units on the ends of the lamp sockets can increase the efficiency of installation and maintenance of the fluorescent lamp.

2. The improvement of the prefabricated socket circuit unit can ensure the simplicity and correctness of installation and maintenance of the fluorescent lamp.

3. The separation of the electronic starter into two units previously, which can improve the function of heat transfer and the convenience of maintenance. It can also reduce the risk of circuit failure and the cost of maintenance.

4. The improvement of the starting capacitor disposed in the holder structure previously, which can be more economical and conservative. As the electronic starter failed, user can keep the starting capacitor and change the failed electronic starter only because of the separation of these components.

5. The separation of starting capacitor from the electronic starter can reduce the number of the connecting pins, such that the user can install or maintain the fluorescent lamp more correctly, efficiently and conveniently.

It is to be understood that both the foregoing general description and the following detailed description are exemplary, and are intended to provide further explanation of the invention as claimed.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic drawing of the fluorescent lamp holder according to a first embodiment of the present invention;

FIG. 2 is a schematic drawing of the conventional electronic starter with six terminals;

FIG. 3 is circuit diagram of joint unit in the electronic starter matching with the fluorescent lamp holder according to a first embodiment of the present invention;

FIG. 4 is a schematic drawing of the fluorescent lamp holder according to a second embodiment of the present invention;

FIG. 5 is a circuit diagram of joint unit in the electronic starter matching with the fluorescent lamp holder according to a second embodiment of the present invention;

FIG. 6 is a circuit diagram of joint unit in the electronic starter matching with the fluorescent lamp holder according to a third embodiment of the present invention; and

FIG. 7 is a circuit diagram of joint unit in the electronic starter matching with the fluorescent lamp holder according to a fourth embodiment of the present invention.

| | |
|---|---|
| 1 . . . electronic starter | 2 . . . external wiring |
| 10 . . . fluorescent lamp holder | 20, 30 . . . lamp socket |
| 40, 50 . . . socket circuit unit | 60 . . . electronic starter |
| | (60 = A + B) |
| A . . . rectifier unit | B . . . electronic lighting unit |
| 61, 62 . . . external power wire | 65 . . . bridge rectifier |
| 63, 64, 67 . . . connecting wire | 66 . . . power factor correction |
| | filter |
| 70 . . . starting capacitor | 71, 72 . . . starting capacitor wire |
| 80 . . . fluorescent lamp | |
| B1 . . . HF power factor transformer | B2 . . . current-limit coil |
| BG1 . . . power factor correction | BG2, BG3 . . . power transistor |
| transistor | |
| C1, C2, C3, C4, C5, C6, C7, | |
| C8 . . . capacitor | |
| D1, D2, D3, D4, D5, D6, D7, D8, | |
| D9 . . . diode | |
| FS . . . fuse | IC1 . . . power factor correction IC |
| L1, L2 . . . HF blocking coil | |
| L31, L32, L33 . . . self-stimulated | |
| coil | |
| R1, R2, R3, R4, R5, R6, R7, R8, | |
| R9 . . . resistor | |
| AC . . . alternating current | DC . . . direct current |

### DETAILED DESCRIPTION OF THE PREFERRED EMBODIMENT

Reference will now be made in detail to the present preferred embodiments of the invention, examples of which are illustrated in the accompanying drawings. Wherever possible, the same reference numbers are used in the drawings and the description to refer to the same or like parts.

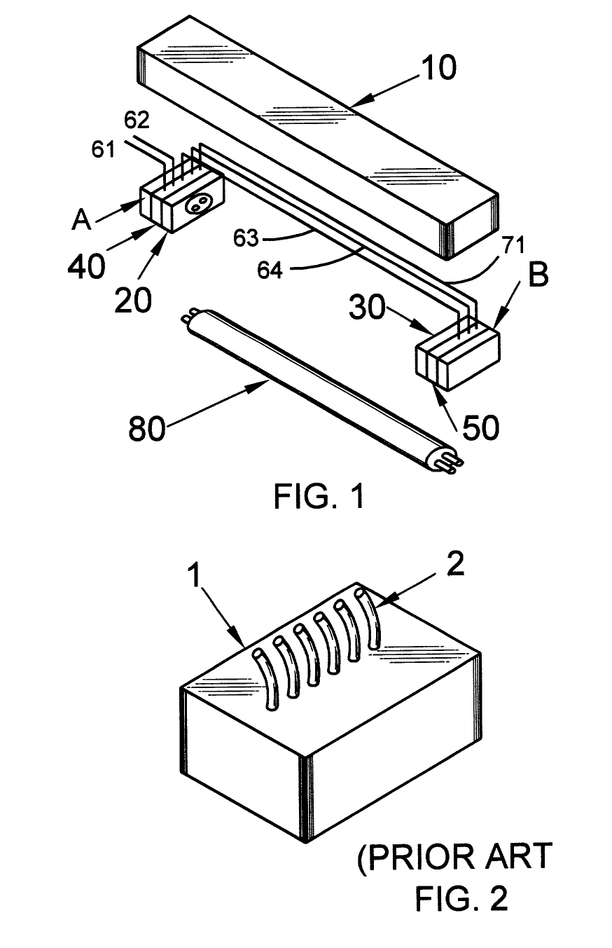

FIG. 1 is a schematic drawing of the fluorescent lamp holder according to a first embodiment of the present invention. In FIG. 1, the socket circuit unit 40, 50 are disposed on the lamp socket 20, 30 that are at the two extremities of the fluorescent lamp holder 10. The socket circuit units 40, 50 work as the control center, and the wiring 61, 62, 63, 64 and 71 are connected to the socket circuit units 40, 50 previously. The electronic starter 60 can be easily set up while installing the fluorescent lamp. The electronic starter 60 is separated into two units: a rectifier unit A and an electronic lighting unit B in advance, these two units can be disposed on the lamp socket 20, 30 mentioned above. The starting capacitor 70, capacitors C4, C5 and current-limit coil B2 of the electronic starting circuit are very easy to give out heat as the lamp connected to power. Thus the starting capacitor 70, capacitors C4, C5 and current-limit coil B2 are included in unit A for the management purpose and transferring the heat generated from the circuit more efficiently. Furthermore, this configuration can reduce the risk of circuit failure and the cost of maintenance, and improve the convenience of installation and maintenance.

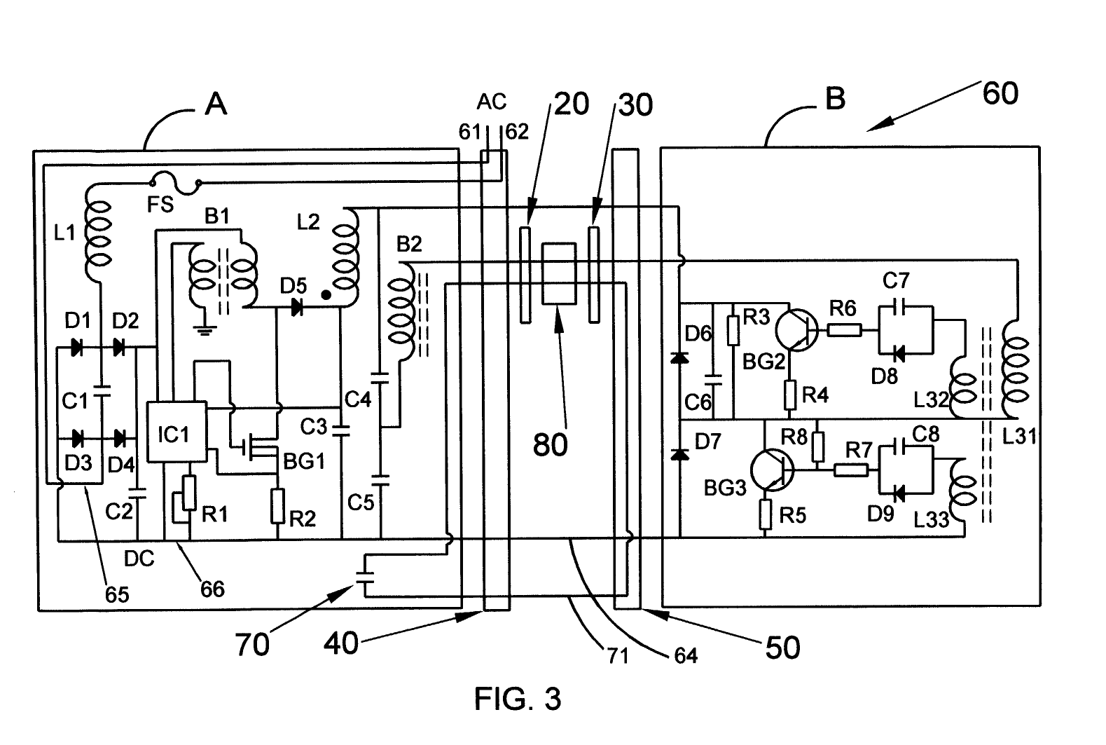

FIG. 3 is a circuit diagram of joint unit in the electronic starter matching with the fluorescent lamp holder according to a first embodiment of the present invention. In FIG. 3, the rectifier circuit, starting capacitor 90 and capacitors C4, C5, and current-limit coil B2 in the structure of the electronic starter 60 are merged into the rectifier unit A. The remainder circuits in the electronic starter are merged into the electronic lighting unit B. In such condition, two external power wires 61, 62 are equipped as usual, wire 63, 64 connecting respectively to the socket circuit units 40, 50 and the starting capacitor wire 71 connecting with the starting capacitor 70 are also needed. Therefore it needs only 5 connecting wires to construct the unit. Other circuits, such as the circuits connected to the lamp sockets 20, 30 are of the internal short-range wiring structure. The wiring structure of the present invention is very simple and clear. Maintenance and update can be carried out very convenient via the plug-in operation.

The rectifier unit A in the lamp holder includes a bridge rectifier 65 and a power factor correction filter 66, wherein a high-frequency blocking coil L1 is disposed in the front end of the bridge rectifier 65 to filter out the high-frequency interference. On the other hand, there is a capacitor C1 in the bridge rectifier 65 for absorption the high-frequency noise.

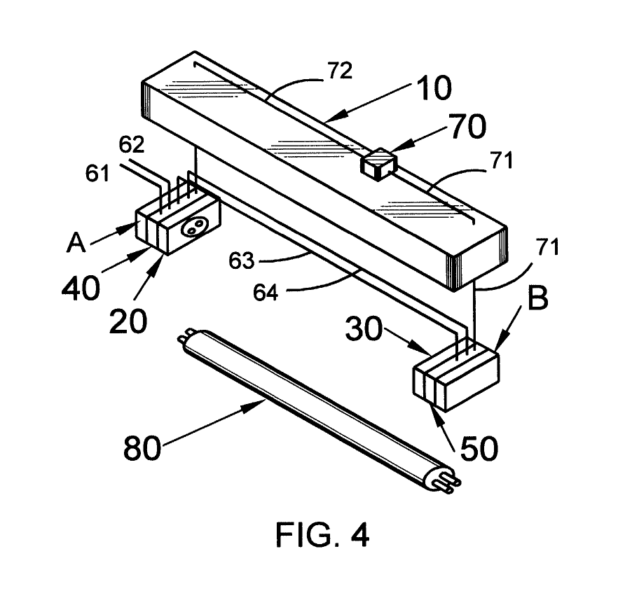

FIG. 4 is a schematic drawing of the fluorescent lamp holder according to a second embodiment of the present invention. In FIG. 4, the starting capacitor 70 is separated from the electronic starter 60 (shown in FIG. 3), and connected to two extremities of the fluorescent lamp via starting capacitor wires 71, 72. The distributed structure of the present invention can reduce the cost of replacing components, which is provided with the economical and environmental advantages. Furthermore, the improvement of the present invention can reduce the number of the connecting pins substantially, which is very helpful for user to install and maintain more efficiently and conveniently.

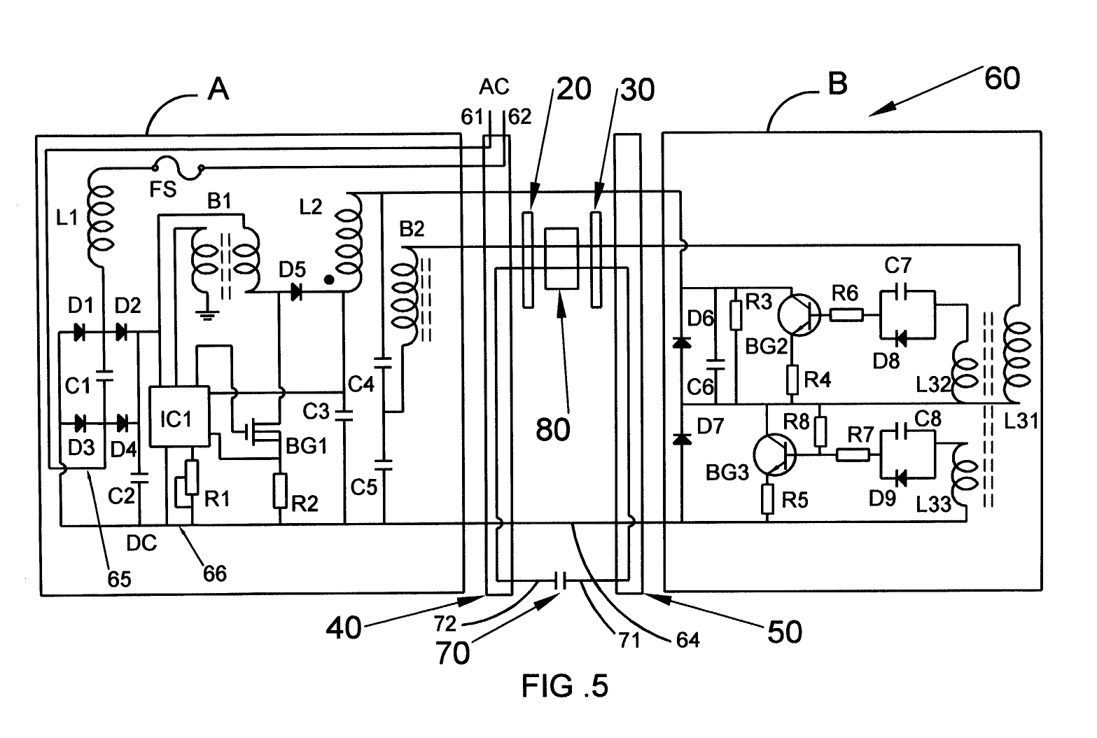

FIG. 5 is a circuit diagram of joint unit in the electronic starter matching with the fluorescent lamp holder according to a second embodiment of the present invention. The major difference of the electronic starters in FIG. 3 and FIG. 5 is that the starting capacitor 70 is separated from the rectifier unit A. The purpose and benefits of this embodiment have been mentioned above in the interpretation of FIG. 4.

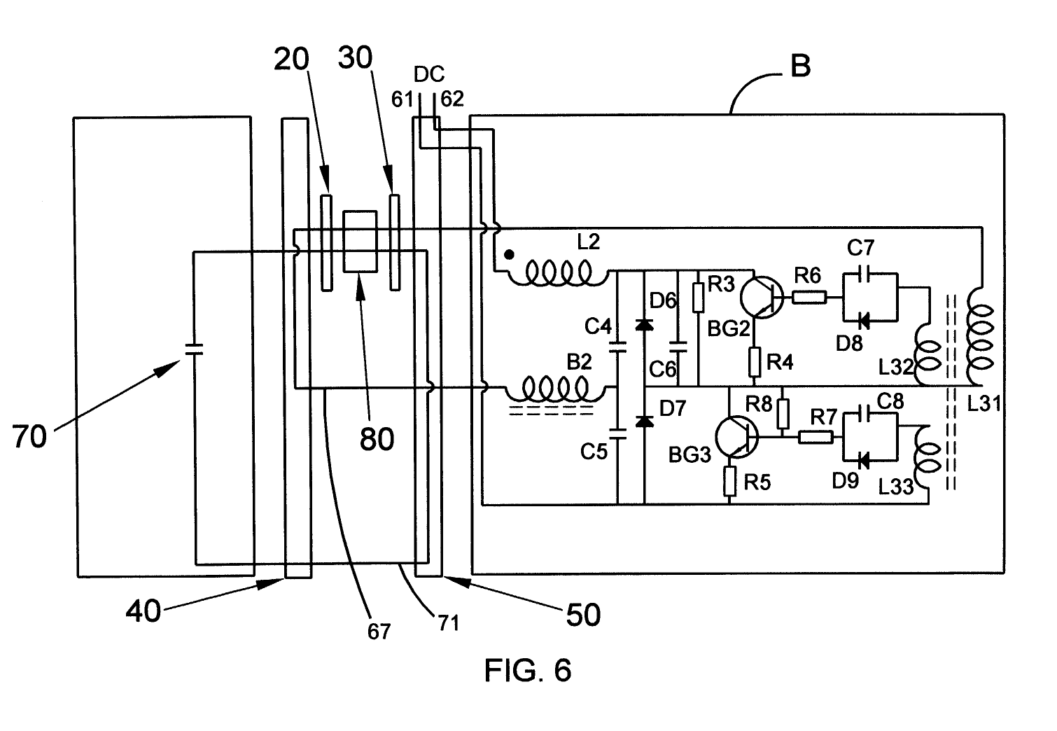

FIG. 6 is a circuit diagram of joint unit in the electronic starter matching with the fluorescent lamp holder according to a third embodiment of the present invention. In FIG. 6, another practical electronic starter circuit is disclosed, where the starting capacitor 70 is separated from the circuit structure of electronic starter 60. The starting capacitor 70 can be plugged in with the electronic starter circuit, which can reduce the complexity of wiring and the number of components to achieve the economical benefits.

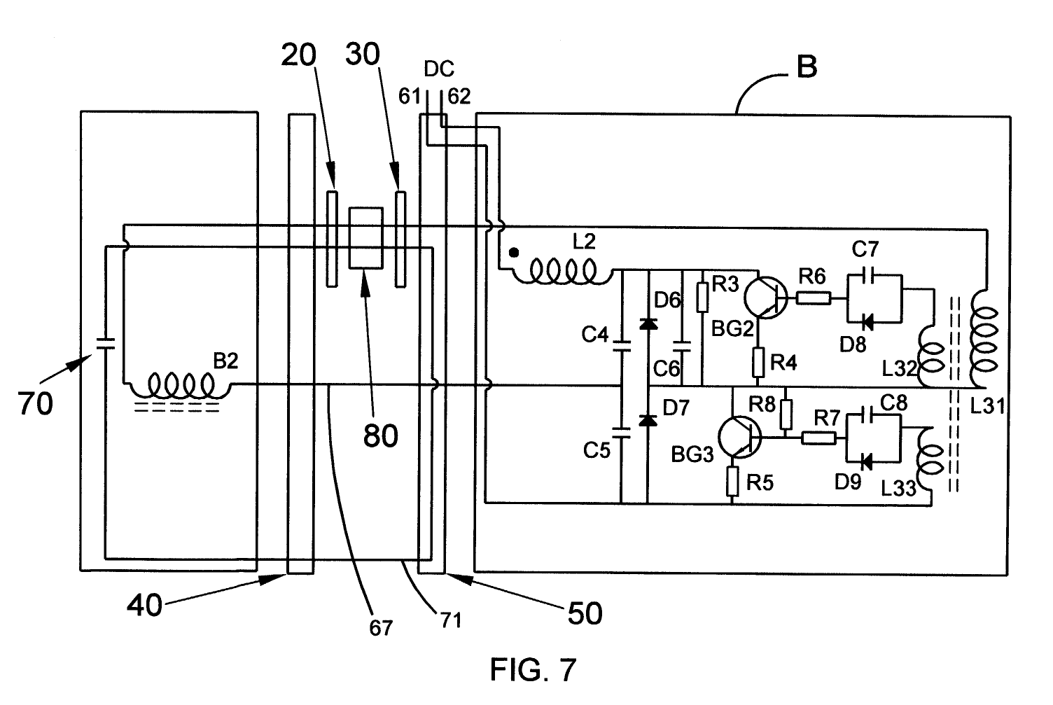

FIG. 7 is a circuit diagram of joint unit in the electronic starter matching with the fluorescent lamp holder according to a fourth embodiment of the present invention. In FIG. 7, the starting capacitor 70 and the current-limit coil B2 are disposed in the same joint unit such that the components giving out heat very easily are separated from other components for the purpose of management based on the economical principles.

In the fourth preferred embodiments mentioned above, the shape of the rectifier unit A and electronic lighting unit B, the joint units described in interpretation of FIG. 6 and FIG. 7 could be circular, square, rectangular or other forms. The rectifier unit A, the electronic lighting unit B and the joint units in FIG. 8 and FIG. 9 should be matched with the relative socket circuit units 40, 50 in any different type. The arrangements and shapes of the joint between these relative components socket could also be provided with any anti-mistake design such as the arrangement of sockets, the shape of sockets or other guiding structure of sockets.

The configuration of the present invention is originated, fresh and non-obvious. The present invention possesses utility, novelty and economic effects as described above, which meets the requirement of Patent. As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A fluorescent lamp holder, comprising:
a socket circuit unit disposed on a lamp holder, wherein the socket circuit unit working as control center having a plurality of wiring connected; and
an electronic starter matched with the socket circuit unit, wherein the electronic starter plugged in and connected with the socket circuit unit,
the fluorescent lamp holder being characterized in that
two sub-units separated from the electronic starter are matched with socket circuit unit disposed on the lamp socket.

2. The fluorescent lamp holder according to claim 1, wherein the electronic starter comprising:
a bridge rectifier; and
a high-frequency blocking coil disposed in the front end of the bridge rectifier to filter out the high-frequency interference.

3. The fluorescent lamp holder according to claim 2, wherein the bridge rectifier in the electronic starter further comprising a capacitor for removing the high-frequency noise.

4. The fluorescent lamp holder according to claim 2, wherein the electronic starter further comprising a power factor correction filter connected with the rear end of the bridge rectifier.

5. The fluorescent lamp holder according to claim 4, wherein the power factor correction filter comprising a power factor correction IC.

6. The fluorescent lamp holder according to claim 4, wherein the power factor correction filter comprising a modular circuit unit.

7. The fluorescent lamp holder according to claim 1, wherein the socket circuit units further comprising matching structures preventing misconnection.

8. The fluorescent lamp holder according to claim 1, wherein the electronic starter further comprising a rectifier unit and an electronic lighting unit, the rectifier unit further comprising a starting capacitor and a current-limit coil.

9. The fluorescent lamp holder according to claim 8, wherein the starting capacitor is independent from the rectifier unit and prefabricated on the lamp holder.

10. The fluorescent lamp holder according to claim 1, wherein the electronic starter further comprising an electronic lighting unit and a starting capacitor connector.

11. The fluorescent lamp holder according to claim 10, wherein the current-limit coil of the electronic starter arranged in the starting capacitor connector.

12. The fluorescent lamp holder according to claim 1, wherein the lamp sockets and the socket circuit units fastened as a whole.

13. The fluorescent lamp holder according to claim 1, wherein the lamp sockets and the socket circuit units bolted as a whole with screws.

14. The fluorescent lamp holder according to claim 1, wherein the lamp sockets and the socket circuit units agglutinated as a whole.
